(19) United States
(12) Patent Application Publication
(10) Pub. No.: US 2007/0051581 A1
(43) Pub. Date: Mar. 8, 2007

(54) Polyvinyl chloride (PVC) feed roller device and method of making the same

(76) Inventor: Robert Anthony Scolly, Londonderry, NH (US)

Correspondence Address: DAVIS & BUJOLD, P.L.L.C., 112 PLEASANT STREET, CONCORD, NH, 03301, US

(21) Appl. No.: 11/219,444

(22) Filed: Sep. 2, 2005

(51) Int. Cl. B65G 13/00

(52) U.S. Cl. 193/37

(57) ABSTRACT

This invention relates to a unique feed roller device for supporting articles and facilitating the movement and handling of such articles in both industrial and domestic applications and more particularly to a method of making the feed roller device from stock pieces of polyvinyl chloride (PVC) pipe and other readily available materials to minimize the cost and increase the ease of manufacturing such feed rollers.

### FIELD OF THE INVENTION

This invention relates to a unique feed roller device for supporting articles and facilitating the movement and handling of such articles in both industrial and domestic applications and more particularly to a method of making the feed roller device from stock pieces of polyvinyl chloride (PVC) pipe and other readily available materials to minimize the cost and increase the ease of manufacturing such feed rollers.

### BACKGROUND OF THE INVENTION

Feed roller devices are known for all types of product manufacturing and article handling. Commonly, feed roller devices are used with industrial and domestic wood or metal working machines where large articles such as bulky and heavy pieces of wood, or metal must be supported and guided by the user towards or into for example a cutting machine. Because such large articles are often manipulated by hand by a user who is unable to support the entire weight of the stock material on his own as it is being cut or machined such feed rollers are imperative to the safe and efficient operation of such machines.

Feed rollers are usually placed immediately adjacent such machines to help support the weight and bulk of large articles and allows the user to easily feed the stock material into the machine with minimal force as the rollers support the weight of the article as well as provide minimal friction as the stock material is being fed into a machine. The weight support and minimal friction are key benefits of such feed rollers as they allow the user to focus their attention on operating the machine in relation to the cutting or machining of the intended article.

Other uses for such feed rollers are as part of a conveyor system for moving articles in industrial applications for instance moving products being manufactured from one work station to another, delivering articles such as baggage from a collection point to a loading point or for passing mail or packages through a sorting system to facilitate the review and further dissemination of the mail. In such conveyor systems, feed rollers are usually made of a metal, and often have a frictional covering such as rubber which is able to more easily retain and move such articles along the conveyor. The rollers are aligned parallel and positioned adjacent one another at a desired spacing apart so as to provide for continuous support of the articles being passed along the conveyor system.

Such rollers may also be part of a conveyor belt system where a rubber belt which overlies the entire group of adjacent rollers and the belt is for instance driven by a motor so as to pass the articles over the adjacent rollers and move the article to a desired location. By having a belt surrounding the rollers, articles will not get stuck or fall through the spacing between the rollers. Such feed rollers can have a ribbed or gear-like surface which align with treads or a track on the inside of a belt, similar to the one previously described. Where a roller, or rollers are driven by a motor for instance the rollers in the conveyor act as gears for driving the belt and hence moving the article over the adjacent positioned rollers.

Some feed rollers which are generally known are constructed as a solid or hollow metal cylinder. The problems with these type of rollers as they are known in the art is that they are heavy and generally expensive to make and purchase. Furthermore, manufacturing a feed roller such as this requires special training as well as tooling and/or access to materials.

### SUMMARY OF THE INVENTION

The present invention provides a simplified and inexpensive PVC feed roller, and method of making the same, for use in conveyor systems or feeding stock material into machinery. The feed roller and method of making the same overcomes certain shortcomings of prior art feed rollers. In particular, feed roller devices are heavy and expensive to manufacture. Feed roller devices also usually require special tooling to manufacture, causing consumers to purchase an expensive commercially made product as opposed to a less costly alternative. The present invention simplifies the complexity of the feed roller manufacturing process by utilizing already commonly available parts and incorporating them into a simple, useful and innovative device or kit for making the device.

The feed roller device of the present invention utilizes a polyvinyl chloride (PVC) tube or pipe, which can be found at nearly every hardware and plumbing supply store, as the cylindrical body for the feed roller device. The use of a PVC pipe body and only two end caps eliminates the expensive manufacturing process required of the rollers already known in the art.

It is an object of the present invention to provide an economical and easy to assemble feed roller device.

It is a further object of the present invention to provide a feed roller device which can be manufactured from easy to obtain components by an ordinary person.

It is a still further object of the present invention to provide a feed roller device which requires only minimal assembly using commonly found parts or certain parts as provided in a kit.

It is another object of the present invention to utilize the strength and durability of polyvinyl chloride tubes to create a feed roller device.

It is yet another object of the present invention to provide a lightweight, easy to move and adjust feed roller device.

The present invention relates to a feed roller device comprising a commercially available hollow, cylindrical, polyvinyl chloride (PVC) body having an outer diameter and an inner diameter extending between a first and second end and defining an axis extending through the center of the body, a first end cap having a through bore defining an axis, a core section to be inserted into one of the first and second ends of the body, and a cap section with a diameter greater than the inner diameter of the body, a second end cap having a through bore defining an axis, a core section to be inserted into one of the first and second ends of the body, and a cap section with a diameter greater than the inner diameter of the body, a frame having a first and second rail each having inner surfaces positioned facing one another and a pair of cylindrical axial supports each axial support protruding from an inner surface of each of the first and second rails such that each pair of axial supports is directly opposite from one another; and wherein each of the cylindrical axial supports extends into the respective through bores of each of the first and second end cap discs, allowing the polyvinyl chloride body to freely rotate about the axis through the body and defined by the axial supports, the end cap through bores and the center of the body.

### BRIEF DESCRIPTION OF THE DRAWINGS

The invention will now be described, by way of example, with reference to the accompanying drawings in which:

FIG. 1 a front elevational view of a feed roller according to an embodiment of the present invention;

FIG. 2a a front elevational view of an end cap of the feed roller according to an embodiment of the present invention;

FIG. 2b a side view of an end cap of the feed roller according to an embodiment of the present invention;

FIG. 2c a cross-sectional side view of an end cap of the feed roller according to an embodiment of the present invention;

FIG. 3 a cross-sectional view of a feed roller according to an embodiment of the present invention;

FIG. 4 a top view of a feed roller device according to an embodiment of the present invention;

FIG. 5 a front elevational view of a rail with several axial supports according to an embodiment of the present invention.

### DETAILED DESCRIPTION OF THE PREFERRED EMBODIMENTS

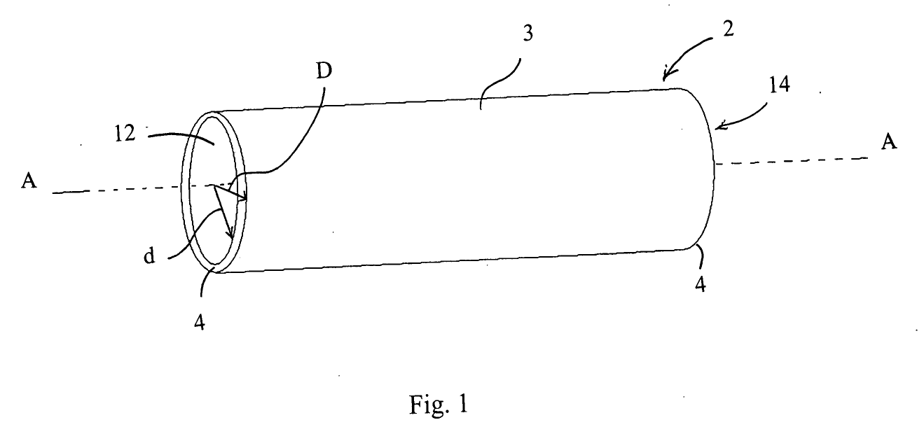

In FIG. 1 a general embodiment of a roller body 2 of the present invention using a polyvinyl chloride (PVC) pipe 3 for the roller body 2 is shown. The PVC for making the cylindrical body is readily available in various lengths and diameters at local hardware stores or in bulk from plumbing suppliers. A standard PVC pipe 3 is a uniform cylindrical body, generally having an outer diameter D ranging from ⅛ inch to 24 inches, and a body wall thickness ranging from 0.06 inch to 0.7 inch generally increasing relative to increases in diameter of the selected pipe 3. For purposes of the present invention the sizing would more generally be in the range of about 1″ to 3″ diameter stock PVC pipe. Because PVC tube and pipe is extruded, the body 2 is generally not restricted in length along its center axis A, however in general PVC body length which is most desirable for the present invention is between 8 and 36 inches, and most preferably about 12-24 inches with an appropriately sized wall thickness.

PVC pipe is particularly good for feed rollers of the type described herein because it is corrosion resistant, and is readily available in numerous sizes, e.g. IPS sizes ¼″ through 24″, for use at temperatures up to and including 140° F. PVC pipe is generally resistant to most acids, bases, salts, aliphatic solutions, oxidants, and halogens. PVC pipe exhibits excellent physical properties and flammability characteristics (independently tested flame and smoke characteristics-ULC). Typical applications include: chemical processing, plating, high purity applications, potable water systems, water and wastewater treatment, irrigation, agricultural, and other industrial applications involving corrosive fluid transfer. However until now, few uses outside the plumbing and piping industry have benefitted from such inexpensive and readily available material.

The body 2 is defined by an inner diameter d and an outer diameter D which in turn defines the thickness of the body wall which, as is known in the industry is maintained at a uniform thickness for the length of any given piece of PVC pipe 3. The thicker the body wall the more shear strength is imparted to the pipe body 2 and therefore it may be beneficial in most feed roller applications to select a schedule of pipe which has the thickest body walls for any given outer diameter D.

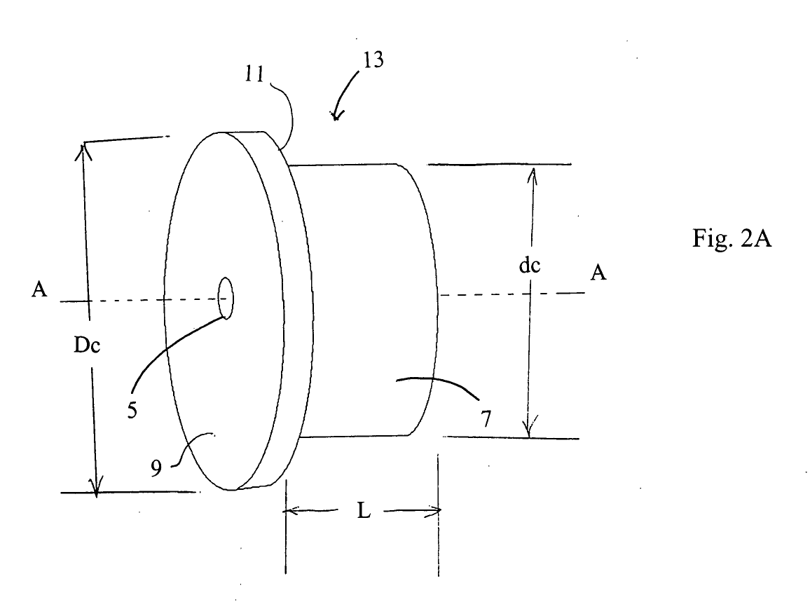

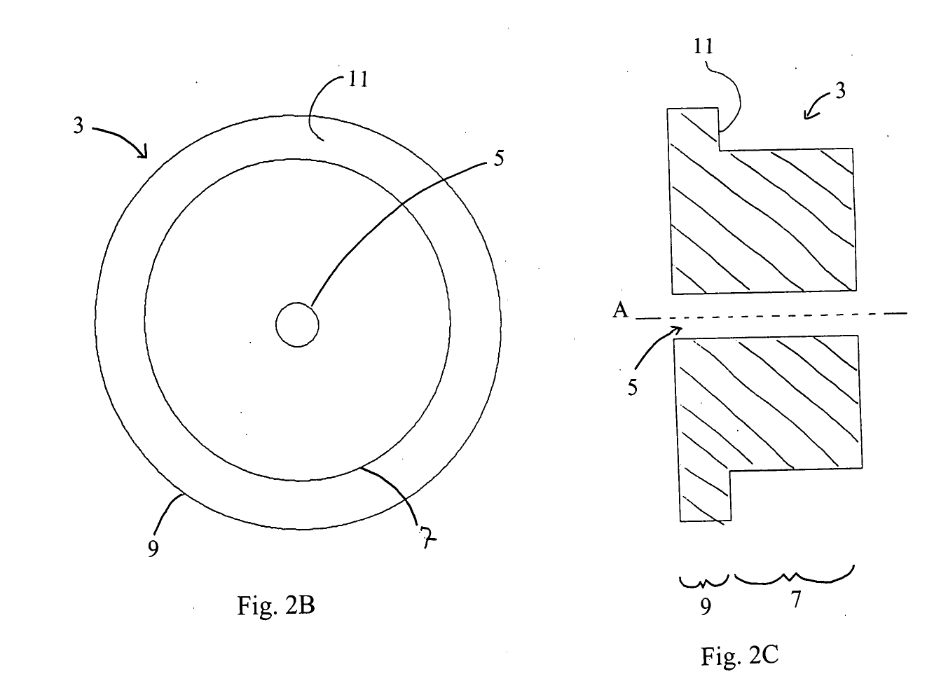

Each roller has a first and a second open ends 12, 14 into which are inserted end caps 13. In FIGS. 2A-C, the end cap 13 is shown in detail. The end caps 13 are designed to seal and support the PVC body 2 on each of the first and second ends. Each end cap 13 is essentially the same having a small hole 5 through its center defining a passage therethrough to align with the center axis A of the PVC body 2. The end cap 3 is a single molded piece generally made of plastic, however any solid material for instance metal or wood could also be used.

Each end cap 13 is a two-tiered, or stepped cylinder having a core section 7 and a cap section 9. The core section 7 is stepped down in diameter and has a smaller outer diameter d_{c} which is generally the same as the inner diameter d of the selected PVC body 2. It is usually preferable that the diameter d_{c} of the core section 7 is only slightly smaller than the inner diameter of the PVC body 2 such that the end cap 13 may be insertable and removable with the body 2 by overcoming only slight friction forces, such that a person could easily insert and remove the end caps by hand. The core section 7 may have an axial length l with extends into the interior of the body 2 to any desired length, even up to half the length of the body 2, however in general the core 7 will extend from about 0.25 inches to 2 inches so as to provide sufficient supporting strength directly to the ends of the body 2.

The cap section 9 of the end cap 13 is connected to but greater in diameter than the core section 7, however the diameter D_{c} of the cap section 9 is generally the same as the outer diameter D of the PVC body 2 so as to provide a contiguous outer surface of the roller from one end to the other. Preferably, the cap section 9 of the end cap 13 is the same as the outer diameter D of the PVC body 2. The cap section 9, like the core 7, can be of any axial length, but is generally between approximately 0.0625 and 0.75 inches in length, and preferably about 0.125 inch.

The cap section 9 is provided with a lip 11 which engages the outer edge or rim of the respective first or second ends 12, 14 of the body 2 when the end cap 13 is inserted into the respective end and closes off any difference in diameter between the inside diameter d of the PVC body 2 and the core section 7 diameter d_{c} of the end cap 3. The cap section 9 not only provides support to the body 2 but also by the stepped design prevents any excess adhesive or other sealant means known in the art from leaking outside the seal between the cap 13 of the PVC body 2 and contaminating the rollers outer surface.

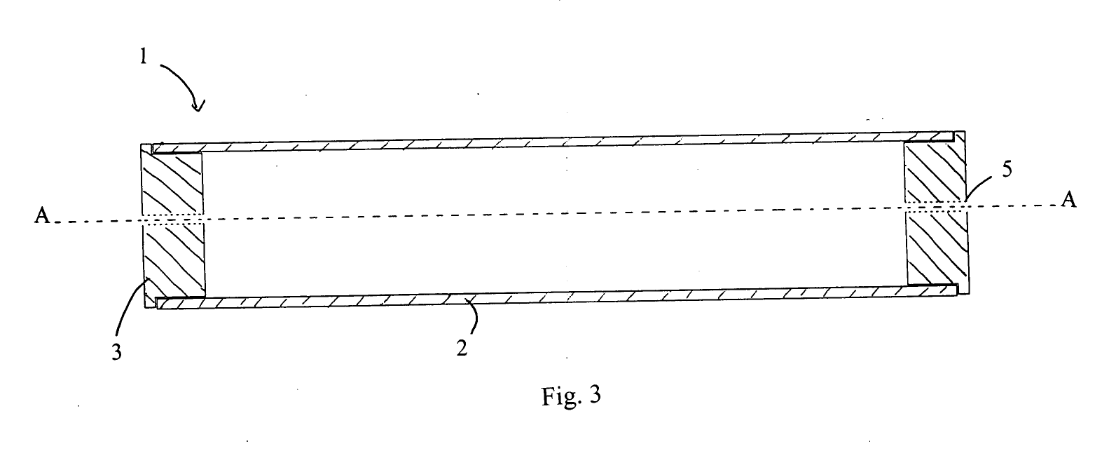

The end cap 13 has a supporting hole 5 as shown in FIGS. 2B-C which is positioned axially in line with the center axis A of the body as previously discussed. When both end caps 13 have been secured onto the respective ends of the body 2, a passage exists through the roller body 2 along the center axis A of the body and through the end caps 13. FIG. 3 shows a cross-sectional view of the positioning of the end caps 13 with the PVC body 2 defining the axis A. This axis A is the axis of axial rotation while the PVC feed roller 1 is being used. It is to be appreciated that an adhesive or other sealant means such as chemical welding or heat welding known in the art may be used to attach the end seals to the respective first and second ends of the body.

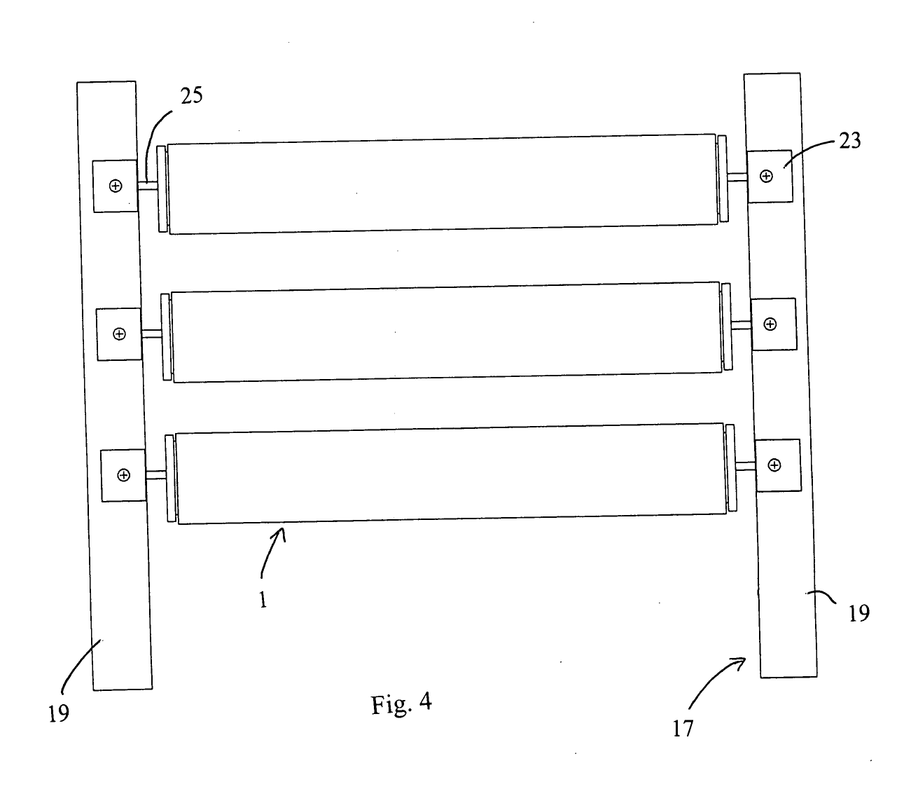

The support for the PVC feed roller 1 consists of a frame 17 which may be made either free-standing with legs (not shown) or supported in any manner as generally known in the art. As shown in FIG. 4, the frame 17 primarily consists of two oppositely positioned rails 19. The rails 19 may be any width or thickness depending upon the application and are maintained at a uniform spacing from one another so as to provide the proper spacing for the length of roller being supported therebetween. The rails 19 may be supported in a moveable or fixed manner relative to the articles which are to be supported thereby, in other words the rails and supported rollers could be portable, or fixed in place.

The rails 19 are maintained at a desired spacing generally permitting that there will be a minimum space between the end caps 13 of the PVC feed rollers 1 and the inside surface 21 of the rails 19 so that the rollers are free to rotate and not bind against the rails 19. The length of the rails 19 will vary depending on the diameter and amount of rollers 1 needed for any given application. For example, if only three PVC feed rollers are needed at 3 inch intervals, 12 inch rails 19 would likely be sufficient. However, where more PVC feed rollers 1 are needed in a given application longer rails 19 would be used.

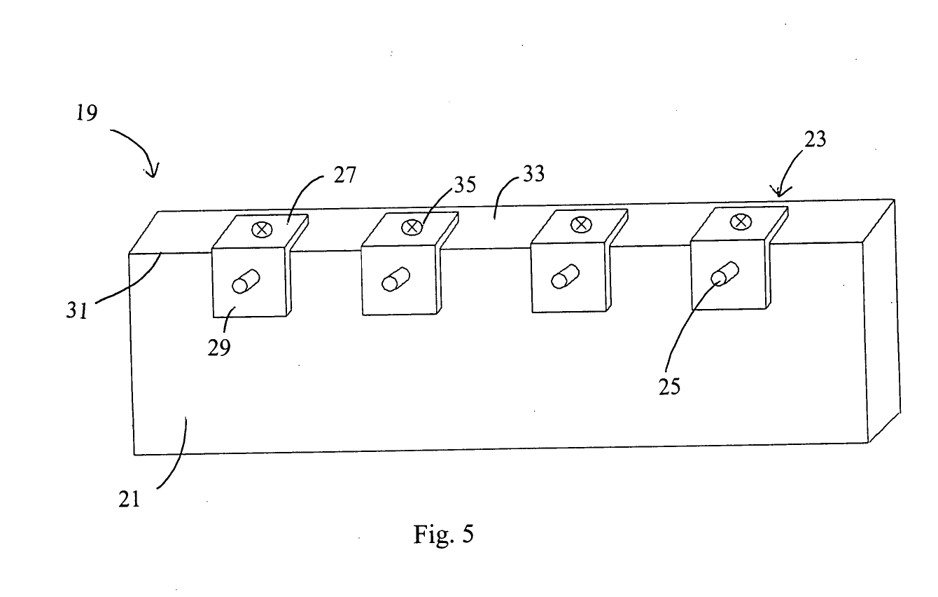

Axial supports 23, shown along one rail 19 in FIG. 5, are used at the desired location for the axis A of the roller. The axial supports 23 provide cylindrical protrusions 25 extending horizontally outward from the inner surface 21 of the rails 19 at a desired height to align the axis A of the body of the roller. For every PVC feed roller 1, two opposing axial supports 23 are needed, i.e. one on each rail to engage opposing first and second ends of the body. The axial supports are positioned and the protrusions 25 sized to insert into the hole 5 in each end cap 13. The axial supports 23 may range in length from a length shorter or equal to the cap section 9 of the end cap 13 to a complete axle running the length of the span between the rails 19.

The axial supports 23 are affixed to angled brackets having a top section 27 and a side section 29 at an angle generally 90 degrees so as to fit on top of the upper inner edge 31 of the rail 19 such that the top section 27 sits flush against the top 33 of the rail 19 and the side section 29 sits flush against the inner surface 21 of the rail 19. The top surface 27 of the axial support may be provided with a hole 35 which allows for a screw, nail or other attachment device to attach the support 23 to the rail 19. The side support 29 surface directly supports the cylindrical protrusion 25 as previously described.

In order to make the above described device one need only obtain a desired diameter of PVC pipe and cut the pipe to any desired length. The end caps 13 which may be manufactured to have the appropriate sized core 7 and cap 9 portion are fabricated or purchased for instance in a kit form, and then applied to the cut PVC pipe so as to enclose the open first and second end of the body 2. The axial supports 23 are placed at the necessary distances along the rails 19 and fastened thereto by screws of other fasteners as known in the art. The rails 19 are then set at a desired distance from one another and, once the frame 17 is fully assembled the PVC feed rollers are placed therein by engaging the protrusions 25 in the holes in the end caps 13 as shown in FIG. 4. The complete assembly of adjacent rollers may be used as a feeding device for various articles such as wood working or metal working machines.

Since certain changes may be made in the above described improvement, without departing from the spirit and scope of the invention herein involved, it is intended that all of the subject matter of the above description or shown in the accompanying drawings shall be interpreted merely as examples illustrating the inventive concept herein and shall not be construed as limiting the invention.

What is claimed is:

1. A feed roller device comprising:
a commercially available hollow, cylindrical, polyvinyl chloride (PVC) body having an outer diameter and an inner diameter extending between a first and second end and defining an axis extending through the center of the body;
a first end cap having a through bore defining an axis, a core section to be inserted into one of the first and second ends of the body, and a cap section with a diameter greater than the inner diameter of the body;
a second end cap having a through bore defining an axis, a core section to be inserted into one of the first and second ends of the body, and a cap section with a diameter greater than the inner diameter of the body a frame having a first and second rail each having inner surfaces positioned facing one another and a pair of cylindrical axial supports each axial support protruding from an inner surface of each of the first and second rails such that each pair of axial supports is directly opposite from one another; and
wherein each of the cylindrical axial supports extends into the respective through bores of each of the first and second end cap discs, allowing the polyvinyl chloride body to freely rotate about the axis through the body and defined by the axial supports, the end cap through bores and the center of the body.

2. The feed roller device as set forth in claim 1 further comprising a plurality of adjacent cylindrical axial supports spaced along each of the first and second rails of the frame to define a respective plurality of parallel axes between each of the first and second rails

3. A method of making a feed roller device comprising the steps of:
obtaining a length of hollow, cylindrical, polyvinyl chloride, PVC, pipe having a desired outer diameter and an inner diameter;
cutting the hollow, cylindrical, polyvinyl chloride, PVC, pipe to a desired length to define a first and second ends further defining a longitudinal axis extending through the axial center of the PVC pipe;
forming a first end cap and a second end cap, each end cap having a core section with a diameter similar to the inner diameter of the PVC pipe, and a second cap section having a diameter substantially the same as the outer diameter of the PVC pipe
boring a hole in the axial center of the first and second end caps;
inserting the core section of each of the first and second end caps into the respective first and second ends of the PVC pipe; and
rotatably supporting the PVC pipe and first and second end caps along the longitudinal axis via at least an axle support rotatably supporting the roller through the holes in the axial centers of the first and second end caps of the roller.

4. A kit for making a feed roller from a polyvinyl chloride, PVC, pipe section, the kit comprising:
a first end cap having a through bore defining an axis, a core section to be inserted into one of the first and second ends of the body, and a cap section with a diameter greater than the inner diameter of the body;
a second end cap having a through bore defining an axis, a core section to be inserted into one of the first and second ends of the body, and a cap section with a diameter greater than the inner diameter of the body;
a pair of cylindrical axial supports, each axial support for engaging the respective through bore of the first and second end caps; and
wherein the first and second end caps are inserted into opposing ends of a section of polyvinyl chloride, PVC, pipe to form the roller body, and each axial support is attached and supported on an opposing rail and the roller body is suspended between the opposing rails by engagement of the through bores in the ends caps with the respective axial supports on the rails.
